(19) United States
(12) Patent Application Publication
(10) Pub. No.: US 2001/0054993 A1
(43) Pub. Date: Dec. 27, 2001

(54) Plasma display panel and method of driving the same capable of providing high definition and high aperture ratio

(76) Inventors: Yoshikazu Kanazawa, Kawasaki (JP); Shigeharu Asao, Kawasaki (JP)

Correspondence Address: STAAS & HALSEY LLP, 700 11TH STREET, NW, SUITE 500, WASHINGTON, DC, 20001, US

(21) Appl. No.: 09/785,272

(22) Filed: Feb. 20, 2001

(30) Foreign Application Priority Data
Jun. 22, 2000 (JP) 2000-188256

(51) Int. Cl. G09G 3/28

(52) U.S. Cl. 345/60

(57) ABSTRACT

A display panel has a plurality of first electrodes, a plurality of second electrodes adjacently disposed alternately with the first electrodes, a plurality of third electrodes formed to cross the first and second electrodes, and a control circuit for having an address discharge carried out during the second electrodes and the third electrodes. The control circuit has a sustain discharge carried out to decrease the volume of wall charges, accumulated on a display cell in which a sustain discharge is not intended, to a level which cannot generate a sustain discharge.

### BACKGROUND OF THE INVENTION

1. Field of the Invention

The present invention relates to a technique of driving a plasma display panel, and more particularly, to a plasma display panel of an ALIS system and a method of driving this plasma display panel.

2. Description of the Related Art

Recently, as a plasma display panel (PDP) that is capable of providing high definition and a high aperture ratio, there has been proposed a PDP of the ALIS (Alternate Lighting of Surfaces) system. In such a PDP of the ALIS system, information display, such as display of characters, is often carried out by repeatedly using only one side of fields in order to avoid a flickering. This has a risk that an abnormal discharge occurs due to a distorted accumulation of electric charges on the display panel. Therefore, there has been a high demand for a provision of a technique of driving a PDP capable of preventing the occurrence of such an abnormal discharge.

Specifically, in the PDP of the ALIS system, when only one field, for example an odd field, is used to carry out a display of information like characters, for example, the address discharge is always in the same direction. When this driving (display) is repeated, a distortion in the electric charge occurs on the display panel. This abnormal discharge can prevent normal operation thereafter, and can damage the circuit by breaking an insulation film with a large current.

The prior art and the problems associated with the prior art will be described in detail, later, with reference to the accompanying drawings.

### SUMMARY OF THE INVENTION

An object of the present invention is to provide a plasma display panel and a method of driving the same capable of preventing an abnormal discharge by eliminating a distorted accumulation of electric charges on the display panel. It is another object of the present invention to provide a plasma display panel and a method of driving the same capable of preventing an erroneous address during an address period.

According to the present invention, there is provided a method of driving a plasma display panel having a plurality of first electrodes, a plurality of second electrodes adjacently disposed alternately, and a plurality of third electrodes formed to cross the first and second electrodes, comprising the steps of carrying out an address discharge between the second electrodes and the third electrodes; carrying out an auxiliary discharge to decrease the volume of wall charges, accumulated on a display cell in which a sustain discharge is not intended, to a level which cannot generate a sustain discharge; and carrying out a sustain discharge by alternately applying sustain pulses to the first and second electrodes.

The method of driving the plasma display panel may further comprise the steps of generating a discharge in a selective cell by applying a voltage pulse, with the third electrode side set to have a first polarity and the second electrode side set to have a second polarity; carrying out an address discharge to form wall charges of a first polarity on at least the second electrodes, with the first electrode side set to have a first polarity with respect to the second electrodes, and also to form wall charges of a second polarity on the first electrode side; and applying a voltage pulse to the first or third electrodes or to both electrodes so as to set the third electrode side to have a first polarity and to set the first electrode side to have a second polarity, thereby generating a discharge in a discharge cell that starts the discharge without an application to this cell of a voltage pulse that brings about an address discharge in the third electrodes.

A voltage to be applied to the third electrodes when carrying out the auxiliary discharge may be equivalent to a voltage of an address pulse for carrying out an address discharge. A voltage to be applied to the second electrodes when carrying out the auxiliary discharge may be a voltage which decreases a potential difference between the voltage applied to the second electrodes and a voltage of an additional pulse to be applied to the first electrodes. The voltage to be applied to the second electrodes when carrying out the auxiliary discharge may be equivalent to a voltage of a non-selective electrode of the second electrodes during an address period. The first electrodes and the second electrodes may be disposed in parallel alternately, and the third electrodes may be orthogonal with the first and second electrodes.

According to the present invention, there is also provided a method of driving a plasma display panel having a plurality of first electrodes, a plurality of second electrodes adjacently disposed alternately, and a plurality of third electrodes formed to cross the first and second electrodes, comprising the steps of carrying out an address discharge between the second electrodes and the third electrodes; carrying out a sustain discharge by alternately applying sustain pulses to the first and second electrodes; and carrying out an auxiliary discharge of a scale larger than the scale of the sustain discharge carried out immediately before.

The method of driving the plasma display panel may further comprise the steps of generating a discharge in a selective cell by applying a voltage pulse with the third electrode side set to have a first polarity and the second electrode side set to have a second polarity; forming wall charges of a first polarity on at least the second electrodes, with the first electrode side set to have a first polarity with respect to the second electrodes, and also forming wall charges of a second polarity on the first electrode side; and applying a voltage pulse to the third or second electrodes or to both electrodes so as to set the third electrode side to have a first polarity and to set the second electrode side to have a second polarity.

A voltage to be applied to the third electrodes when carrying out the auxiliary discharge may be equivalent to a voltage of a voltage pulse to be applied to the third electrodes in order to execute an address discharge during an address period. A voltage to be applied to the third electrodes when carrying out the auxiliary discharge may have a polarity opposite to the polarity of the potentials of the second and third electrodes during a sustain discharge period. A voltage to be applied to the second electrodes when carrying out the auxiliary discharge may be equivalent to a voltage selectively applied to the second electrodes at the time of carrying out an address discharge.

A voltage to be applied to the first electrodes when carrying out the auxiliary discharge may be a voltage having a polarity opposite to the polarity of the second electrodes. The voltage to be applied to the first electrodes when carrying out the auxiliary discharge may be equivalent to a voltage to be applied to the first electrodes at the time of carrying out an address discharge. The auxiliary discharge may be carried out once in a plurality of sub-fields. The auxiliary discharge may be carried out once in one frame or in one field. The first electrodes and the second electrodes may be disposed in parallel alternately, and the third electrodes may be orthogonal with the first and second electrodes.

Further, according to the present invention, there is provided a method of driving a plasma display panel having a plurality of first electrodes, a plurality of second electrodes adjacently disposed alternately, and a plurality of third electrodes formed to cross the first and second electrodes, for applying at a reset timing an erasing pulse having a dull inclination (having a long rising or falling edge) with respect to the second electrodes to which a scan pulse is applied, comprising the step of steeply changing a pulse voltage (having a rising or falling edge sufficiently shorter than that of the erasing pulse) until the pulse voltage becomes equivalent to a voltage of the scan pulse, at an end stage of the erasing pulse.

According to the present invention, there is also provided a plasma display panel comprising a plurality of first electrodes; a plurality of second electrodes adjacently disposed alternately with the first electrodes; a plurality of third electrodes formed to cross the first and second electrodes; and a control circuit for having an address discharge carried out during the second electrodes and the third electrodes, wherein the control circuit carries out a sustain discharge to decrease the volume of wall charges, accumulated on a display cell in which a sustain discharge is not intended, to a level which cannot generate a sustain discharge.

In addition, according to the present invention, there is provided a plasma display panel comprising a plurality of first electrodes; a plurality of second electrodes adjacently disposed alternately with the first electrodes; a plurality of third electrodes formed to cross the first and second electrodes; and a control circuit for having an address discharge carried out during the second electrodes and the third electrodes, wherein the control circuit has an auxiliary discharge carried out in a scale larger than the scale of a sustain discharge carried out immediately before.

The first electrodes and the second electrodes may be disposed in parallel alternately, and the third electrodes may be orthogonal with the first and second electrodes.

According to the present invention, there is also provided a method of driving a plasma display panel having a plurality of first electrodes, a plurality of second electrodes adjacently disposed alternately, and a plurality of third electrodes formed to cross the first and second electrodes, comprising the steps of carrying out an address discharge between the second electrodes and the third electrodes; and carrying out a sustain discharge by alternately applying sustain pulses to the first and second electrodes, wherein an auxiliary discharge is carried out between the first electrodes and the third electrodes, during the address discharge and the sustain discharge.

### BRIEF DESCRIPTION OF THE DRAWINGS

The present invention will be more clearly understood from the description of the preferred embodiments as set forth below with reference to the accompanying drawings, wherein:

FIG. 1A and FIG. 1B are diagrams showing a comparison between a plasma display panel (PDP) of the ALIS system to which the present invention is applied and a conventional plasma display panel;

FIG. 2 is a diagram for explaining a method of displaying a PDP of the ALIS system;

FIG. 3A and FIG. 3B are diagrams for explaining the operation principle of a PDP of the ALIS system;

FIG. 4 is a diagram showing one example of a display sequence of a PDP of the ALIS system;

FIG. 5 is a diagram (an odd field) showing one example of a driving waveform according to the ALIS system;

FIG. 6 is a diagram (an even field) showing one example of a driving waveform according to the ALIS system;

FIG. 7 is a circuit block diagram showing one example of a PDP of the ALIS system to which the present invention is applied;

FIG. 8 is a diagram showing one example of a panel structure of a PDP of the ALIS system;

FIG. 9 is a diagram showing a state of carrying out a fixed display based on a single field (odd field);

FIG. 10 is a diagram showing one example of a lighting sequence of a fixed display based on only the single field shown in FIG. 9;

FIG. 11 is a diagram (part 1) for explaining a problem of a fixed display in a PDP of the ALIS system;

FIG. 12A and FIG. 12B are diagrams (part 2) for explaining a problem of a fixed display in a PDP of the ALIS system;

FIG. 13 is a diagram (part 3) for explaining a problem of a fixed display in a PDP of the ALIS system;

FIG. 14 is a diagram (part 4) for explaining a problem of a fixed display in a PDP of the ALIS system;

FIG. 15A and FIG. 15B are diagrams (part 5) for explaining a problem of a fixed display in a PDP of the ALIS system;

FIG. 16 is a diagram showing one example of a driving waveform according to a conventional method of driving a PDP;

FIG. 17 is a diagram showing a driving waveform according to a first embodiment of a method of driving a plasma display panel (PDP) relating to the present invention;

FIG. 18A and FIG. 18B are diagrams for explaining the operation of the method of driving a PDP shown in FIG. 17;

FIG. 19 is a diagram showing a driving waveform according to a second embodiment of a method of driving a PDP relating to the present invention;

FIG. 20 is a diagram showing a driving waveform according to a third embodiment of a method of driving a PDP relating to the present invention;

FIG. 21 is a diagram showing a driving waveform according to a fourth embodiment of a method of driving a PDP relating to the present invention;

FIG. 22 is a diagram showing a driving waveform according to a fifth embodiment of a method of driving a PDP relating to the present invention;

FIG. 23 is a diagram showing another example of a driving waveform according to a conventional method of driving a PDP; and

FIG. 24 is a diagram showing a driving waveform according to a sixth embodiment of a method of driving a PDP relating to the present invention.

### DETAILED DESCRIPTION OF THE PREFERRED EMBODIMENTS

Before making a detailed description of the present invention, there will be first explained a conventional plasma display panel, a conventional method of driving the plasma display panel, and problems in the conventional techniques, with reference to the drawings.

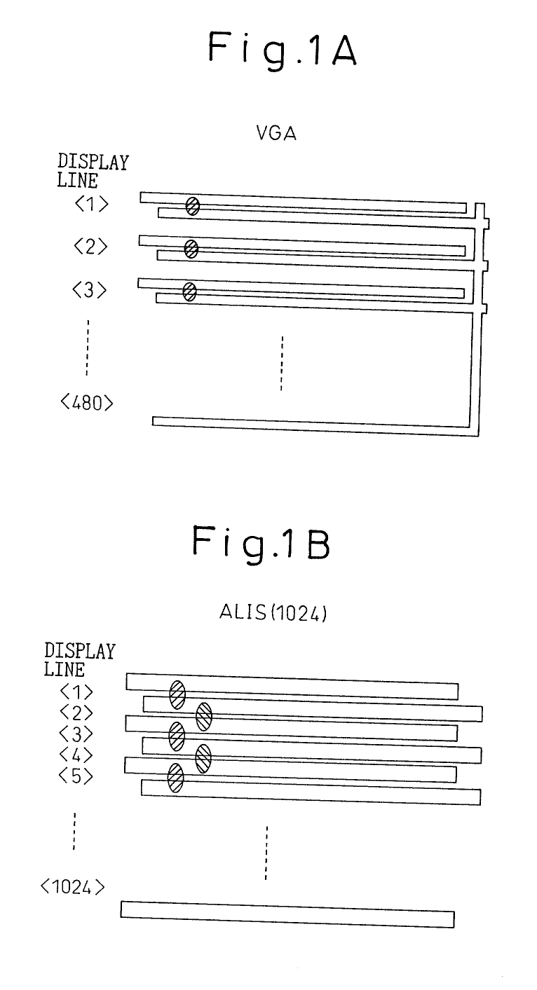

FIG. 1A and FIG. 1B are diagrams showing a comparison between a plasma display panel (PDP) of the ALIS system to which the present invention is applied and a conventional plasma display panel. FIG. 1A shows a conventional PDP (for example, VGA: having 480 display lines), and FIG. 1B shows a PDP of the ALIS system (for example, having 1,024 display lines).

As shown in FIG. 1A, the conventional PDP has two display electrodes disposed in parallel. In order to carry out a display discharge between these electrodes, it is necessary to provide display electrodes (also called a sustain electrode) having two times the number of display lines. For example, in the case of a VGA having 480 display lines, 480×2=960 display electrodes have been necessary.

On the other hand, in the case of the PDP of the ALIS system, a display is carried out by generating a discharge between all the adjacent electrodes as disclosed in, for example, Japanese Patent No. 2801893 (Japanese Unexamined Patent Publication (Kokai) No. 09-160525: corresponding to EP 0762373-A2), and as shown in FIG. 1B. According to this system, a required number of display electrodes is the number of display lines plus one. For example, when there are 1,024 display lines, the required number of electrodes is 1,024+1=1,025.

In other words, according to the PDP of the ALIS system, it is possible to achieve a high definition of two times that achieved by the conventional system, by using a number of electrodes equivalent to that of the conventional system. Further, according to the PDP of the ALIS system, it is possible to minimize the shielding of light beams due to electrodes, based on an efficient use of discharging space without a waste. As a result, a high aperture ratio can be obtained, and a high brightness can be realized.

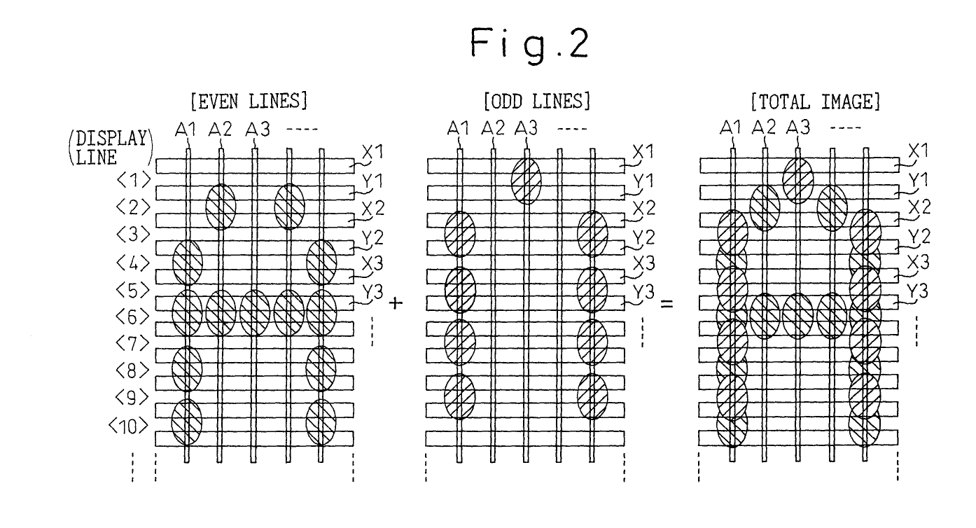

FIG. 2 is a diagram for explaining a method of displaying a PDP of the ALIS system. This shows an example of displaying a character “A”. In FIG. 2, X-electrodes X1, X2, - - - , and Y-electrodes Y1, Y2, - - - are display electrodes (sustain electrodes). A1, A2, - - - are address electrodes.

As shown in FIG. 2, according to the display method of the ALIS system, the display of an image is divided into odd lines and even lines in time order. For example, a display is made on odd lines (display lines <1>, <3>, <5>, - - - ) based on the discharge between the X-electrodes (X1, X2, - - - ) and the Y-electrodes (Y1, Y2, - - - ) below these X-electrodes. Also, a display is made on even lines (display lines <2>, <4>, <6>, - - - ) based on the discharge between the Y-electrodes (Y1, Y2, - - - ) and the X-electrodes (X2, X3, - - - ) below these Y-electrodes. These two sets of displays are combined together to make a display of a whole image. This display method is very similar to that of an interlace scanning of a picture tube.

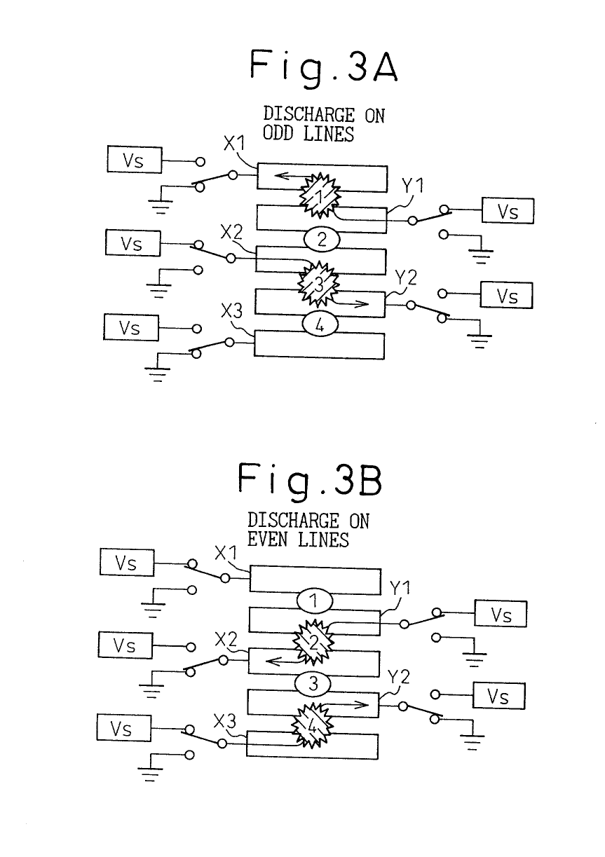

FIG. 3A and FIG. 3B are diagrams for explaining the operation principle of a PDP of the ALIS system. FIG. 3A shows the operation during a discharge (display) of the odd lines, and FIG. 3B shows the operation during a discharge (display) of the even lines.

As shown in FIG. 3A, in order to make a stable discharge on the odd display lines (display lines <1>, <3>, - - - ), for example, the odd X-electrodes X1, X3, - - - are grounded (for example, zero volt), a voltage Vs is applied to the odd Y-electrodes Y1, Y3, - - - , a voltage Vs is applied to the even X-electrodes X2, X4, - - - , and the even Y-electrodes Y2, Y4, - - - are grounded. Based on this arrangement, a current is discharged to the odd display lines <1>, <3>, - - - , and a current is not discharged to the even lines <2>, <4>, - - - . In other words, a current is discharged to the first display line <1> based on a voltage (Vs) generated between the grounded first X-electrode X1 and the first Y-electrode Y1 to which the voltage Vs has been applied. Further, a current is discharged to the third display line <3> based on a voltage (Vs) generated between the second X-electrode X2 to which the voltage Vs has been applied and the grounded second Y-electrode Y2. In this case, a current is not discharged to the second display line <2> as there occurs no potential difference between the first Y-electrode Y1 to which the voltage Vs has been applied and the second X-electrode X2 to which the voltage Vs has been applied. Further, a current is not discharged to the fourth display line <4> as there occurs no potential difference between the grounded second Y-electrode Y2 and the grounded third X-electrode X3.

On the other hand, as shown in FIG. 3B, in order to make a stable discharge on the even display lines (display lines <2>, <4>, - - - ), for example, a voltage Vs is applied to the odd X-electrodes X1, X3, - - - and to the odd Y-electrodes Y1, Y3, - - - , and the even X-electrodes X2, X4, - - - , and the even Y-electrodes Y2, Y4, - - - are grounded. Based on this arrangement, a current is discharged to the even display lines <2>, <4>, - - - , and a current is not discharged to the odd lines <1>, <3>, - - -. In other words, a current is discharged to the second display line <2> based on a voltage (Vs) generated between the first Y-electrode Y1 to which the voltage Vs has been applied and the grounded second X-electrode X2. Further, a current is discharged to the fourth display line <4> based on a voltage (Vs) generated between the grounded second Y-electrode Y2 and the third X-electrode X3 to which the voltage Vs has been applied. In this case, a current is not discharged to the first display line <1> as there occurs no potential difference between the first X-electrode X1 to which the voltage Vs has been applied and the first Y-electrode Y1 to which the voltage Vs has been applied. Further, a current is not discharged to the third display line <3> as no potential difference occurs between the grounded second X-electrode X2 and the grounded second Y-electrode Y2.

By alternately repeating the discharge on the odd lines shown in FIG. 3A and the discharge on the even lines shown in FIG. 3B, the discharge of the odd lines and the discharge of the even lines are combined together. As a result, a total image is displayed.

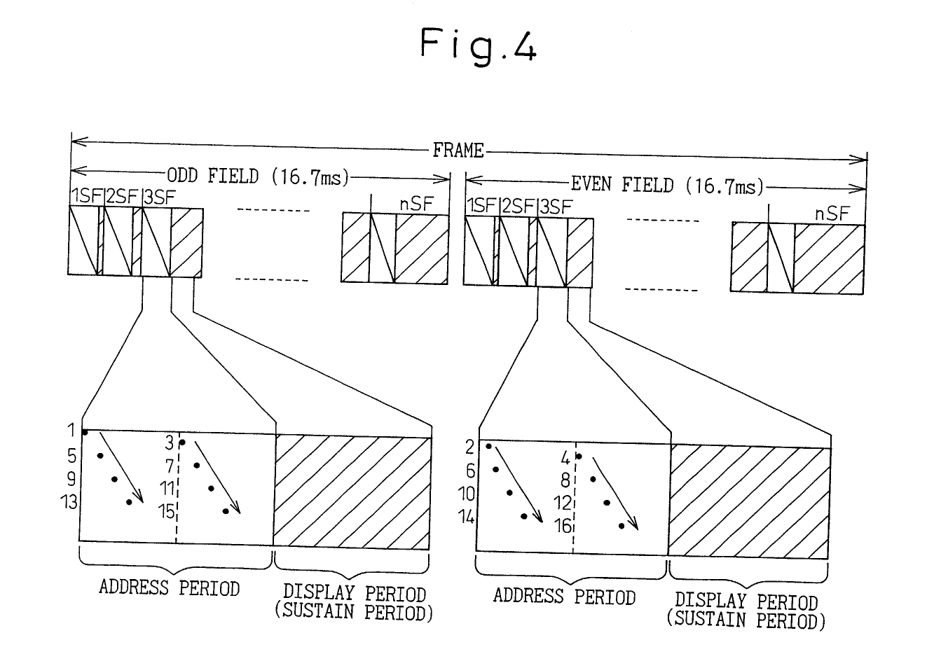

FIG. 4 is a diagram showing one example of a display sequence of a PDP of the ALIS system.

As explained above, according to the PDP of the ALIS system, a display of a total screen is carried out by dividing the display into a display (discharge) of the odd lines and a display of the even lines. Therefore, one frame is divided into an odd field and an even field as shown in FIG. 4. Each of these odd and even fields is further divided into a plurality of sub-fields (1SF to nSF). It is necessary to divide each field into the plurality of sub-fields in order to carry out a gradation display. Usually, in order to realize a graduation of about 50 to 300, each field is divided into about eight to twelve sub-fields (SF).

Each sub-field (4SF to nSF) is further divided into a reset period (not shown in FIG. 4: positioned before an address period) for initializing a state of the discharge cell, an address period for writing into a lighting cell according to a display data, and a display period (a sustain period) for making a display using a cell selected during the address period. During the display period, a discharge is carried out repeatedly (a sustain discharge). The weight of the brightness of each sub-field is determined based on the number of this repetition.

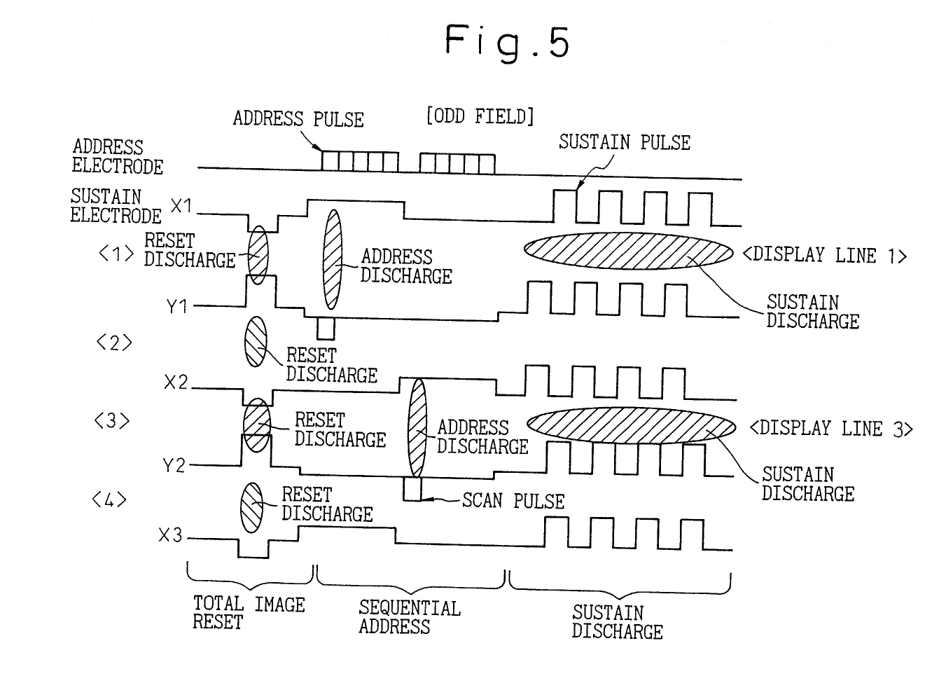

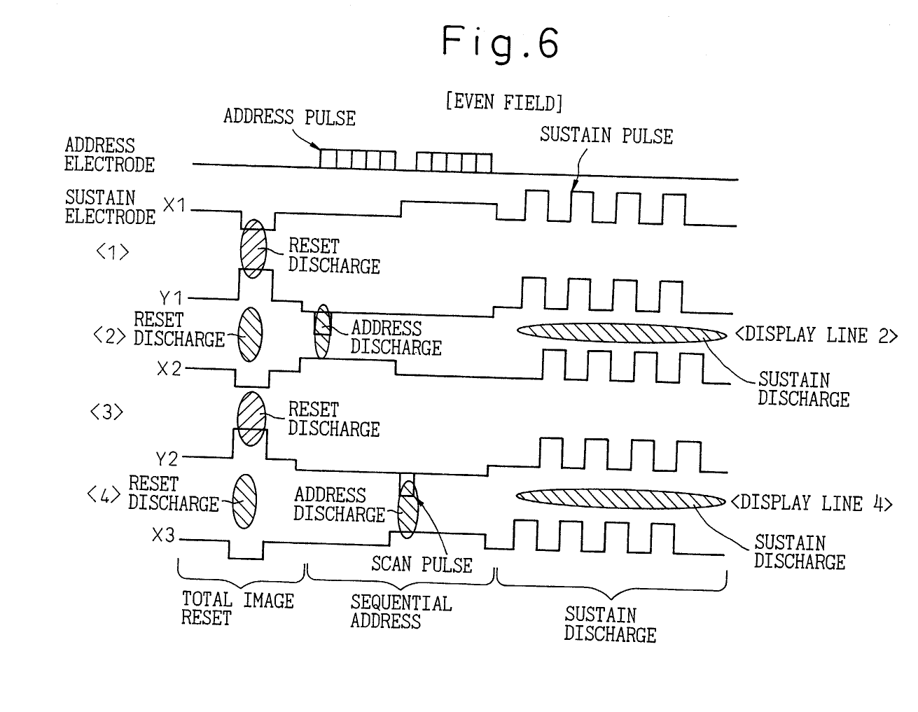

FIG. 5 is a diagram (part 1: an odd field) showing one example of a driving waveform according to the ALIS system, and FIG. 6 is a diagram (part 2: an even field) showing one example of a driving waveform according to the ALIS system. Each drawing shows a driving waveform of one sub-field.

As shown in FIG. 5, in the driving waveform of one sub-field in the odd field, a voltage pulse is applied to between all the adjacent X-electrodes X1, X2, - - - and Y-electrodes Y1, Y2, - - - , thereby to carry out an initial discharge (a reset discharge), during the reset period. During the address period, a selective pulse (a scan pulse) is sequentially applied to the Y-electrodes Y1, Y2, - - - , and an address pulse is applied to the address electrode (A1, A2, - - - ) corresponding to a selective cell, thereby executing a write discharge (an address discharge). After executing the reset discharge and the write discharge to the whole screen, a sustain pulse is applied alternately to the X-electrodes and the Y-electrodes, thereby executing a sustain discharge (a sustain discharge). FIG. 5 shows a driving waveform of the odd field for carrying out a display of the odd lines (odd display lines <1>, <3>, - - - ). In FIG. 5, the address discharge and the sustain discharge are generated to only the odd display lines.

FIG. 6 shows a driving waveform of the even field for displaying the even lines (the even display lines <2>, <4>, - - - ). This corresponds to the driving waveform in the odd field shown in FIG. 5. In FIG. 6, the address discharge and the sustain discharge are generated at only the even display lines.

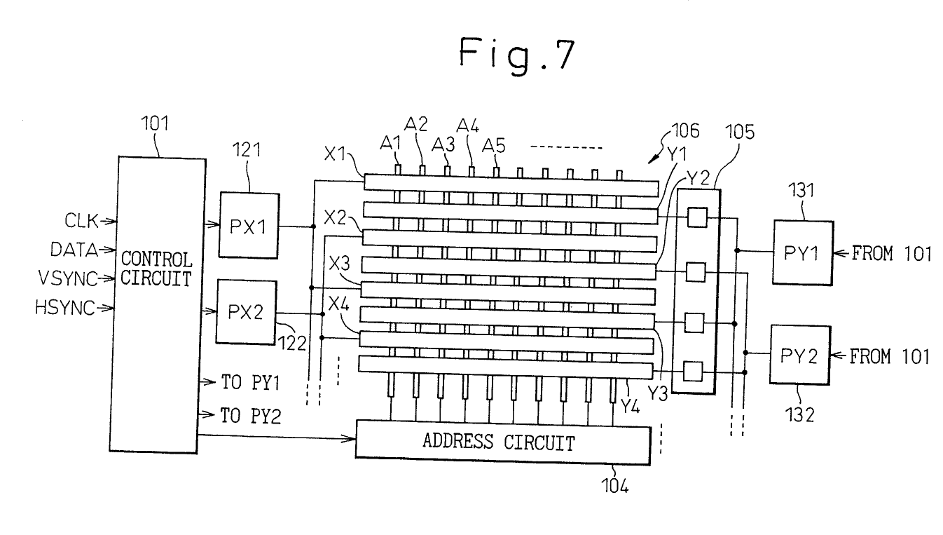

FIG. 7 is a circuit block diagram showing one example of a PDP (a PDP apparatus) of the ALIS system to which the present invention is applied. In FIG. 7, a reference symbol 101 denotes a control circuit, 121 denotes a sustain circuit for odd X-electrodes (PX1), 122 denotes a sustain circuit for even X-electrodes (PX2), 131 denotes a sustain circuit for odd Y-electrodes (PY1), 132 denotes a sustain circuit for even Y-electrodes (PY2), 104 denotes a n address circuit (an address driver), 105 denotes as canning circuit (a scan driver), and 106 denotes a display panel (PDP).

The control circuit 101 converts display data DATA supplied from the outside into data for the display panel 106, and supplies the converted data to the address circuit 104. The control circuit 101 further generates various control signals according to a clock CLK, a vertical synchronization signal VSYNC, and a horizontal synchronization signal HSYNC, and controls the circuits 121, 122, 131, 132, 104, and 105. In order to apply the voltage waveforms shown in FIG. 5 and FIG. 6 to the electrodes, a power source (not shown) supplies predetermined voltages to the sustain circuit for odd X-electrodes 121, the sustain circuit for even X-electrodes 122, the sustain circuit for odd Y-electrodes 131, the sustain circuit for even Y-electrodes 132, the address circuit 104, and the scanning circuit 105, respectively.

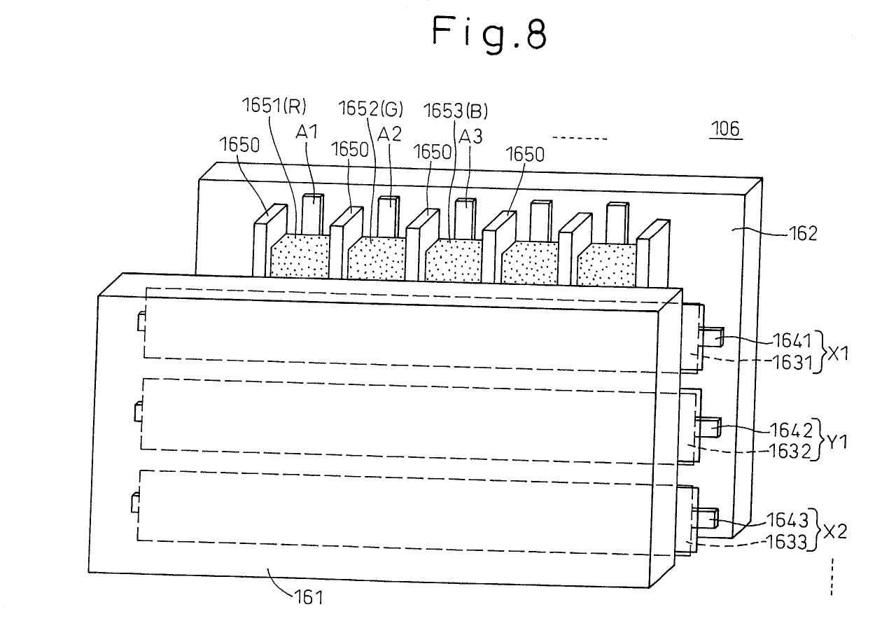

FIG. 8 is a diagram showing one example of a panel structure of a PDP of the ALIS system. The display panel 106 includes a color type and a monochromatic type. FIG. 8 shows a case of the color display panel.

As shown in FIG. 8, on a front glass substrate 161, there are alternately formed in parallel the X-electrodes and Y-electrodes X1, Y1, X2, - - - that are structured by transparent electrodes like ITO films 1631, 1632, 1633, - - - and metal electrodes like copper electrodes 1641, 1642, 1643, - - - . In this case, in the X-electrode X1, for example, the metal electrode 1641 is provided along a longitudinal direction of its transparent electrode 1631 in order to decrease a reduction in the voltage due to the transparent electrode 1631. A dielectric for holding a wall charge and a protection film like an MgO film (not shown) are provided over the whole surface of the transparent electrodes 1631, 1632, 1633, - - - and the metal electrodes 1641, 1642, 1643, - - - that constitute the X-electrodes and Y-electrodes X1, Y1, X2, - - - , and over the whole inner surface of the front glass substrate 161.

On a rear glass substrate 162, there are formed the address electrodes A1, A2, A3, - - - and partitions 1650 surrounding these address electrodes, in a direction orthogonal with the X-electrodes and the Y-electrodes X1, Y1, X2, - - - , on the surface opposite to the MgO protection film of the front glass substrate 161. Phosphors 1651, 1652, 1653, - - - that emit various colors (a red color R, a green color G, and a blue color B) based on an incidence of ultraviolet rays generated by a discharge are coated on the address electrodes A1, A2, A3, - - - that are surrounded by the partitions 1650. A Penning mixed gas of Ne+Xe is sealed into a discharge space formed between the MgO protection film (the inner surface) of the front glass substrate 161 and the phosphors (the inner surface) of the rear glass substrate 162.

The odd X-electrodes X1 (X3, X5, - - - ) of the front glass substrate 161 are connected to the sustain circuit for odd X-electrodes 121 shown in FIG. 7, and the even X-electrodes X2 (X4, X6, - - - ) are connected to the sustain circuit for even X-electrodes 122. The odd Y-electrodes Y1 (Y3, Y5, - - - ) are connected to the sustain circuit for odd Y-electrodes 131 via the scanning circuit 105 (the IC for scan driving) 105, and the even Y-electrodes Y2 (Y4, Y6, - - - ) are connected to the sustain circuit for even Y-electrodes 132 via the scanning circuit 105. Based on this arrangement, the above-described driving of the ALIS system is carried out.

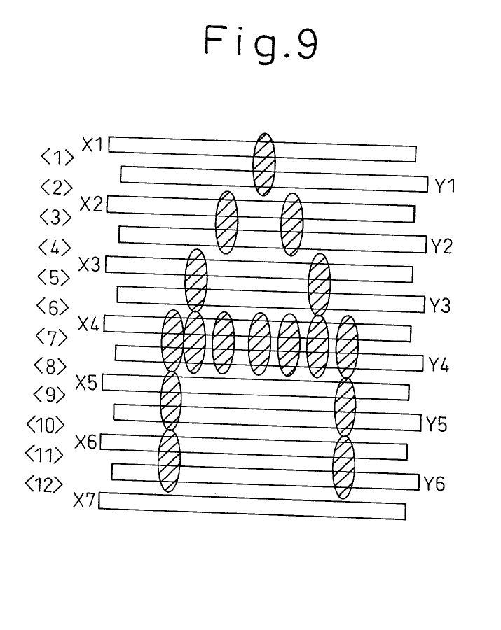

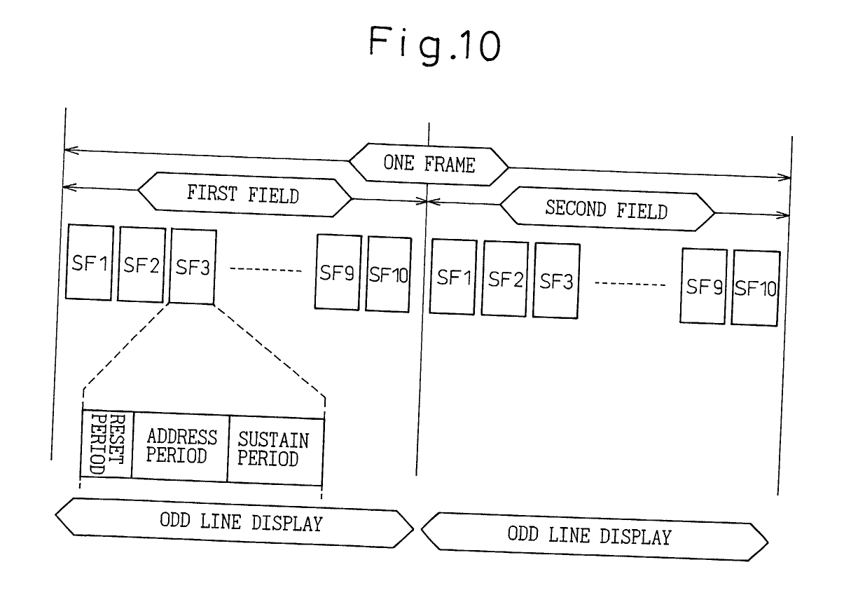

FIG. 9 is a diagram showing a state of carrying out a fixed display based on a single field (the odd field), and FIG. 10 is a diagram showing one example of a lighting sequence of a fixed display based on only the single field shown in FIG. 9.

As explained previously, the PDP of the ALIS system operates by lighting the odd lines and the even lines by separate fields as shown in FIG. 4. As the display sequence in the PDP of the ALIS system has a display state similar to that of the interlace display, a flickering of 30 Hz, for example, occurs in the lighting of one line. Usually, this flickering is not so serious a problem in the case of a video display like that on a picture tube. However, when the PDP is used for a display of information like characters, it is preferable that there is no flickering. When the PDP is used for this purpose, the lines used for carrying out a display are fixed. In other words, a display is carried out by always repeating the odd field or the even field.

More specifically, in the PDP of the ALIS system, when there is a request for avoiding a flickering at the cost of a reduction in the resolution to a half in the display of information like characters, only one field, for example, the odd field, is repeatedly used to carry out a display as shown in FIG. 10. In this case, the number of lines that can be used for making a display is decreased to a half of the total lines, as is apparent from FIG. 9.

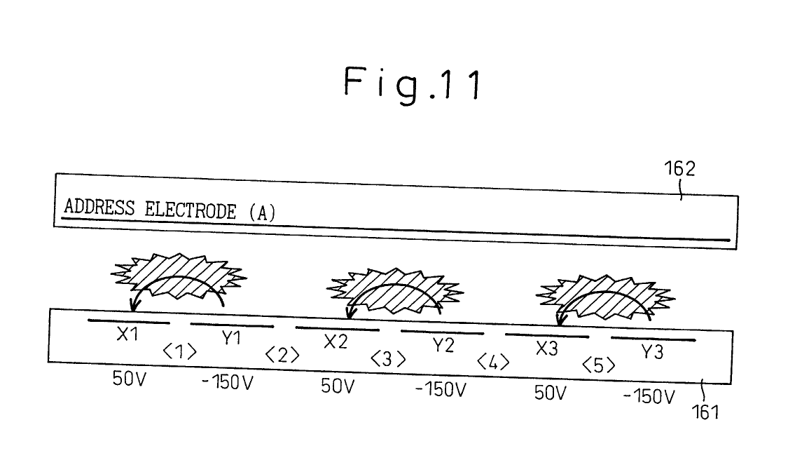

FIGS. 11 to 15B are diagrams for explaining the problem of a fixed display in a PDP of the ALIS system. In FIGS. 11 to 15B, a reference symbol 161 denotes a front glass substrate, and 162 denotes a rear glass substrate.

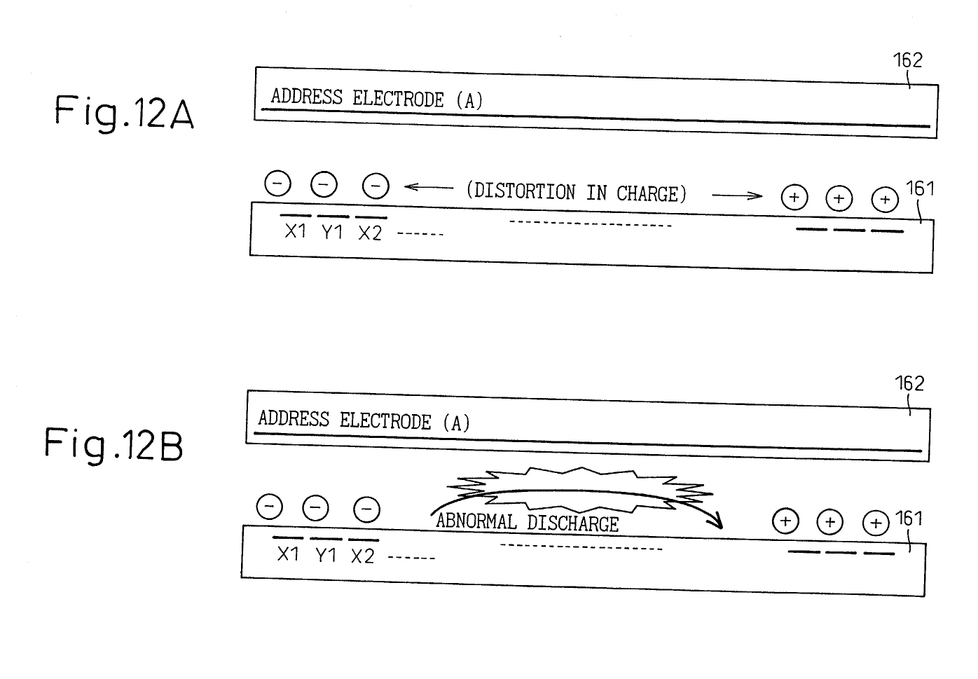

As described above, in the PDP of the ALIS system, when only one field, for example the odd field, is used to carry out a display of information like characters, for example, the address discharge is always in the same direction as shown in FIG. 11. When this driving (display) is repeated, a distortion in the electric charge occurs on the display panel as shown in FIG. 12A.

FIG. 11 shows a state of an address discharge. During the address discharge period, a discharge occurs between the X-electrodes and the Y-electrodes on the front glass substrate by triggering a discharge between the address electrode (A) provided on the rear glass substrate 162 and the Y-electrodes provided on the front glass substrate 161. In this case, a pulse of about 50 to 80 V is applied to the address electrodes according to the display data, and a scan pulse of about −150 V to −200 V is applied the Y-electrodes. With this arrangement, a voltage between the address electrodes and the Y-electrodes exceeds a discharge starting voltage, and the discharge starts. When a voltage of about 50 to 100 V has been applied in advance to the X-electrodes, the discharge generated between the address electrodes and the Y-electrodes extends to between the X-electrodes and the Y-electrodes. This discharge converges based on the accumulation of the wall charge. Electrons and ions generated by the discharge move based on the electric field within the discharge space. The electrons move to the X-electrodes side as an anode, and the ions move to the Y-electrodes side as a cathode. In the sustain discharge after the address discharge, a discharge is carried out even in the opposite polarity. However, the sustain discharge is carried out at a voltage of about 150 to 180 V which is lower than a potential difference of about 200 V between the X-electrodes and the Y-electrodes during the address period. Thus, a charge moved during the address period cannot be completely recovered.

By repeating the above operation, the electrons move to the left side (the upper side of the display panel) in FIG. 12A, for example. The ions are in a surplus state in the right side (the lower side of the display panel) from which the electrons have been removed. While details of this phenomenon have not yet been made clear, this state is considered to occur due to the larger mobility of the electrons compared to that of the ions.

When the accumulated charge becomes larger than a certain level after repeating this display operation, a large-scale abnormal discharge may occur over a substantially long distance exceeding the distance between the pairs of the X-electrodes and the Y-electrodes as shown in FIG. 12B. This abnormal discharge can prevent a normal operation thereafter, and can damage the circuit by breaking an insulation film with a large current.

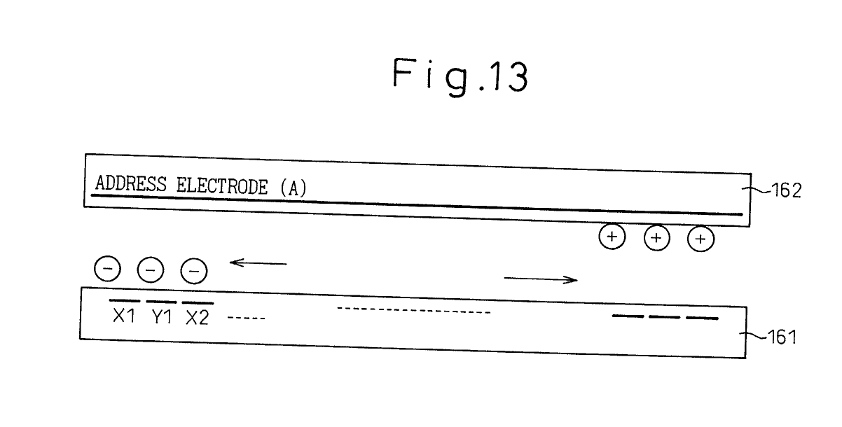

Further, as shown in FIG. 13, the distorted charge can be accumulated at the address electrode (A) side of the rear glass substrate 162, or can be accumulated at the sustain electrode (X-electrodes and Y-electrodes) side of the front glass substrate 161. This state is different depending on the time in the driving sequence. For example, in the case of the driving waveform shown in FIG. 5, the address electrodes are always at zero voltage during the sustain period. Therefore, at the end of the sustain period, distorted plus charges are held in the address electrodes. In this case, the wall charge works so as to be superimposed on the applied voltage at the address electrodes when the address discharge is carried out in the next sub-field. This may result in a huge address discharge. When the discharge is larger than a normal address discharge, this may result in an occurrence of an abnormal display like writing into the adjacent cells.

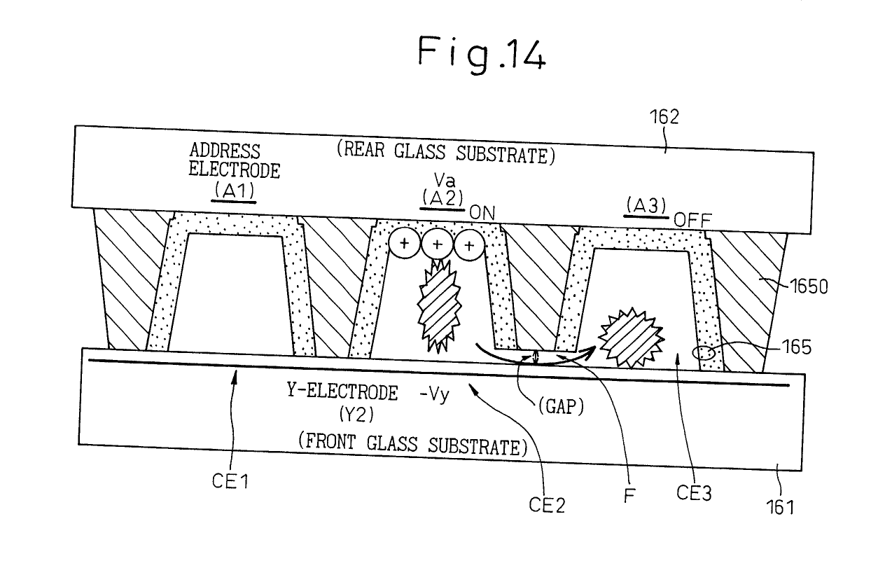

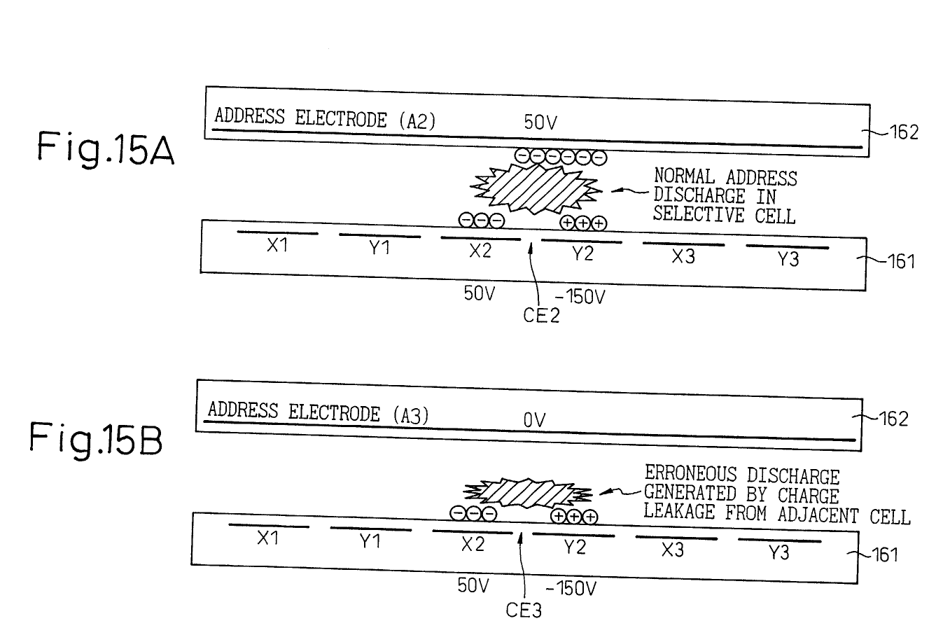

Further, when there is a defect in the partitions or barriers for partitioning the adjacent cells, an abnormal discharge may occur as shown in FIG. 14. In FIG. 14, a reference symbol 165 denotes a phosphor (R1651, G1652, and B1653), and 1650 denotes a partition. FIG. 15A and FIG. 15B show a state that this abnormal discharge occurs.

When an address discharge is carried out in a center cell CE2, and also when cells CE1 and CE3 at both sides of this cell CE2 are in the OFF state, that is, no address discharge is carried out in the cells CE1 and CE3, the following phenomenon may occur. That is, in the above state, when there is a defect F in the partition 1650, a space of the cell CE2 in which the address discharge has been carried out and a space of the adjacent cell CE3 are coupled together, and a charge generated by the address discharge in the cell CE2 moves to the adjacent cell CE3, thereby discharge in the cell CE3. This phenomenon can occur when the defect F of the partition 1650 is a small gap of about 5 μm. When the address electrode charge becomes huge due to the accumulation of a distorted charge, this invites a discharge in the adjacent cell despite a slight gap. A gap between the front glass substrate 161 and the rear glass substrate 162 is about 100 to 150 μm, for example.

As a result, after carrying out a normal address discharge in a selected cell as shown in FIG. 15A, an erroneous discharge can occur due to a leakage of a charge from the adjacent cell as shown in FIG. 15B. FIG. 15A shows the cell CE2 that consists of the address electrode A2 and the sustain electrodes (the X-electrode X2 and the Y-electrode Y2), and FIG. 15B shows the cell CE3 that consists of the address electrode A3 and the sustain electrodes (X2 and Y2).

Embodiments of a method of driving a plasma display panel (PDP) relating to the present invention will be explained in detail below with reference to the drawings.

First, a driving waveform in a first embodiment of a method of driving a PDP according to the present invention will be explained in comparison with a driving waveform according to a conventional method of driving a PDP.

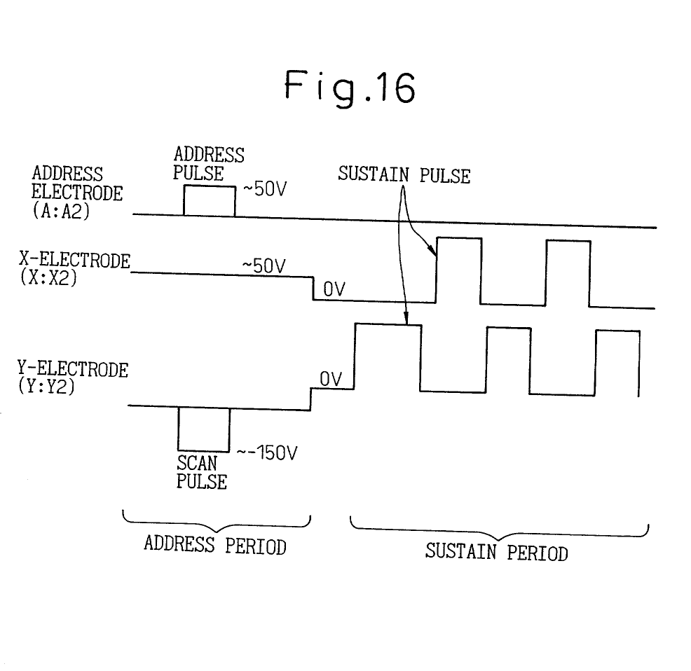

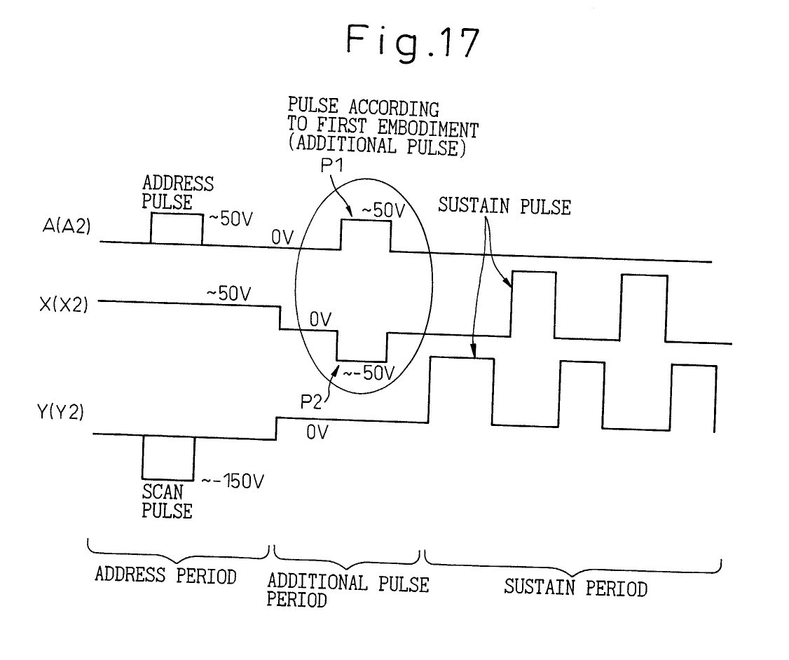

FIG. 16 is a diagram showing one example of a driving waveform according to a conventional method of driving a PDP, and FIG. 17 is a diagram showing a driving waveform according to a first embodiment of a method of driving a PDP relating to the present invention. In FIG. 16 and FIG. 17, a reference symbol A denotes a waveform to be applied to an address electrode (A2), X denotes a waveform to be applied to an X-electrode (X2), and Y denotes a waveform to be applied to a Y-electrode (Y2).

As is apparent from the comparison between FIG. 16 and FIG. 17, according to the first embodiment, additional pulses P1 and P2 are applied to the address electrode (A: A2) and the X-electrode (X: X2) respectively before starting a sustain discharge (before a sustain period) after finishing an address period. With this application, a wall charge of a cell in which an erroneous discharge occurred is extinguished by an auxiliary discharge.

In other words, as shown in FIG. 17, according to the first embodiment, during an additional pulse period between the address period (the address discharge period) and the sustain period (the sustain discharge period), a positive polarity pulse P1 (in this case, the same voltage as that of the address pulse (for example, 50 V) to simplify the circuit)) is applied to the address electrode, and a minus polarity pulse (for example, −50 V) is applied to the X-electrode. Based on the application of these pulses (additional pulses), it is possible to generate an auxiliary discharge in only the cell in which an erroneous discharge has occurred.

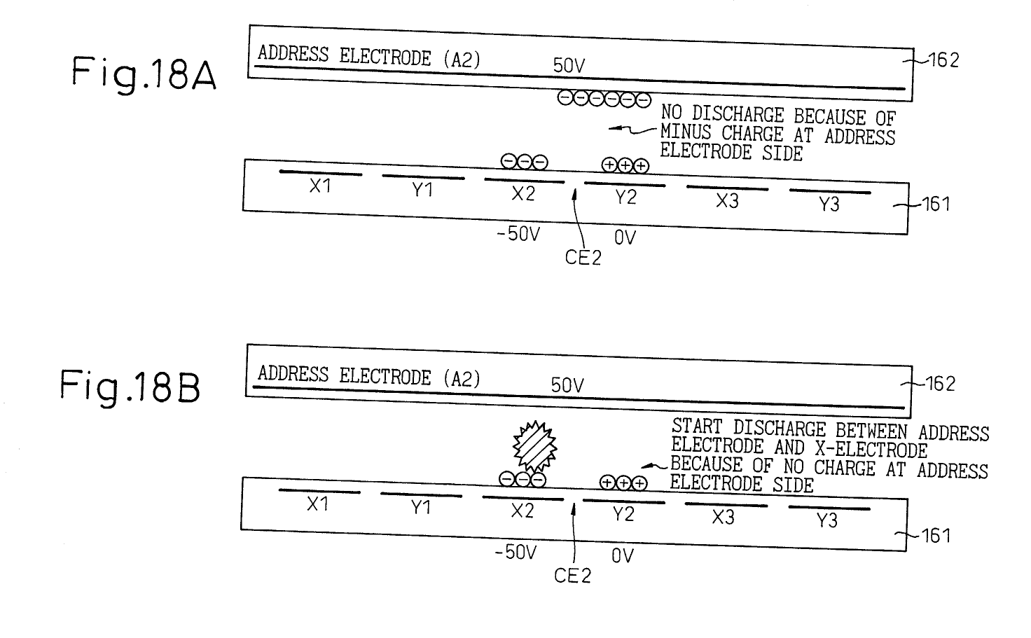

FIG. 18A and FIG. 18B are diagrams for explaining the operation of the method of driving a PDP shown in FIG. 17. FIG. 18A shows a state immediately after an application of the additional pulses shown in FIG. 17 after carrying out the normal address discharge shown in FIG. 15A, and FIG. 18B is a diagram for explaining the operation based on the application of the additional pulses.

As shown in FIG. 18A, a cell (CE2) in which a normal address discharge has been carried out has a minus wall charge formed on the address electrode (A2) side by the address electrode. Therefore, there is no occurrence of a discharge in this cell. On the other hand, as shown in FIG. 18B, in a cell (CE3) in which a discharge has occurred during the address period due to the influence of the adjacent cell (CE2), the address electrode has a non-selective potential of 0 V at the time of this discharge. Therefore, this cell (CE3) has a state that a charge is not formed even when a discharge is carried out between the X-electrode (X2) and the Y-electrode (Y2).

Thus, as shown in FIG. 17 and FIG. 18B, the positive polarity pulse P1 (for example, 50 V) is applied to the address electrode (A2), and the positive polarity pulse P2 (for example, −50 V) is applied to the X-electrode (X2), thereby starting a discharge between the address electrode (A2) and the X-electrode (X2). After starting the discharge, the discharge converges as the formation of a wall charge progresses. However, as the potential difference between the X-electrode (X2) and the Y-electrode (Y2) is about 50 V, this discharge converges immediately after the starting of this discharge unlike the normal sustain discharge. Further, the wall charge formed has a small volume.

Based on this wall charge of a small volume, a sustain discharge is not started even when a sustain pulse is applied next. As a result, it is possible to realize an extinguished state. When a voltage of the negative polarity pulse P2 to be applied to the X-electrode is too large, a discharge occurs even in the cell in which a normal discharge has been carried out, and this has a potential of erasing the charge. Therefore, it is necessary to set a proper value for this voltage of the pulse P2. According to the first embodiment, about −50 V is a limit. A minimum value of the negative pulse P2 that brings about the effect of the first embodiment is about −30 V.

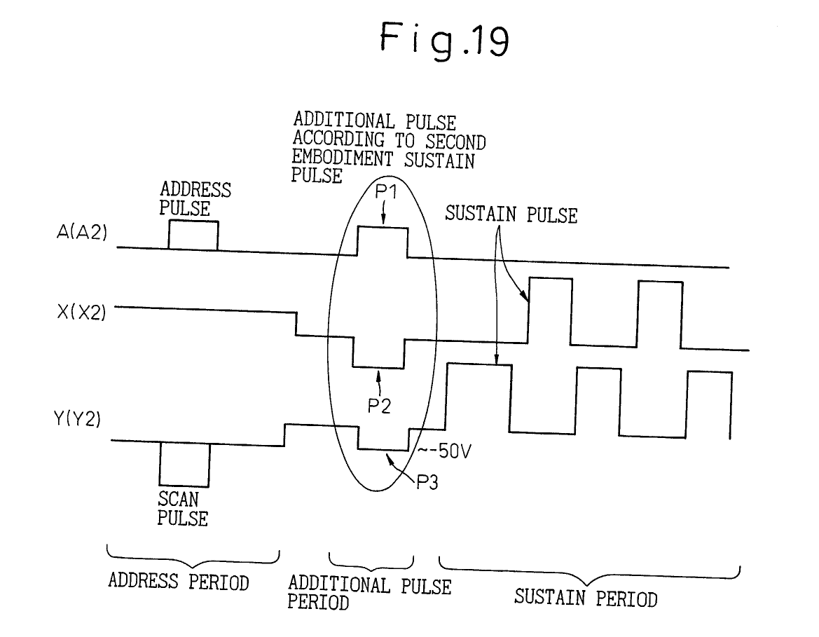

FIG. 19 is a diagram showing a driving waveform according to a second embodiment of a method of driving a PDP relating to the present invention.

While the voltage of the Y-electrode (Y2) is 0 V in the first embodiment shown in FIG. 17, a positive charge exists on the Y-electrode (Y2) as shown in FIG. 18A and FIG. 18B. Therefore, when a negative voltage has been applied to the X-electrode (X2) in the cell (CE2) in which a normal address discharge has been carried out, a discharge may occur between the X-electrode (X2) and the Y-electrode (Y2). This has a risk of extinguishing the wall charge formed by the address discharge. In order to prevent the wall charge from being extinguished, according to the second embodiment, a negative polarity pulse P3 is also applied to the Y-electrode (Y2). Based on this arrangement, even when a large negative polarity pulse is applied to the X-electrode, this does not affect the cell in which a normal address discharge has been carried out. Thus, the effect of the present invention can be exhibited securely by the second embodiment. In an experiment, the voltage of the negative polarity pulse (P3) to be applied to the Y-electrode when the address period is set equivalent to that of the non-selective potential (for example, −50 V).

In the above-described first and second embodiments, it is not possible to prevent an occurrence of an erroneous discharge during the address period. However, before entering the sustain period, it is possible to prevent surplus lighting by extinguishing a wall charge of the cell in which an erroneous discharge has occurred.

An embodiment of a method of preventing surplus lighting during the address period will be explained next.

As shown in FIG. 11 to FIG. 14, the huge address discharge is a phenomenon that occurs due to a formation of a charge displaced in one direction when the address discharge is always carried out in the constant direction. Particularly, this phenomenon occurs easily when a positive charge has been formed at the address electrode side as shown in FIG. 13 and FIG. 14. The phosphors 165 exist at the address electrode (A) side, and these phosphors 165 are particles of a few μm having various shapes based on the materials, unlike the MgO film (the protection film) at the sustain electrode (the X-electrode and the Y-electrode) side. In other words, each phosphor 165 forms a film having a size of around 10 microns, with particles of a few μm superimposed with each other. Therefore, each phosphor 165 has hollows in many portions and has a larger surface area in total than that of the MgO surface. When charged particles like electrons and ions enter these hollows and are adhered to their surface, a fine reset discharge or a sustain discharge cannot remove these charged particles. As a result, the charged particles are pile and generate a huge discharge.

An embodiment of a method of removing the charged particles will be explained next.

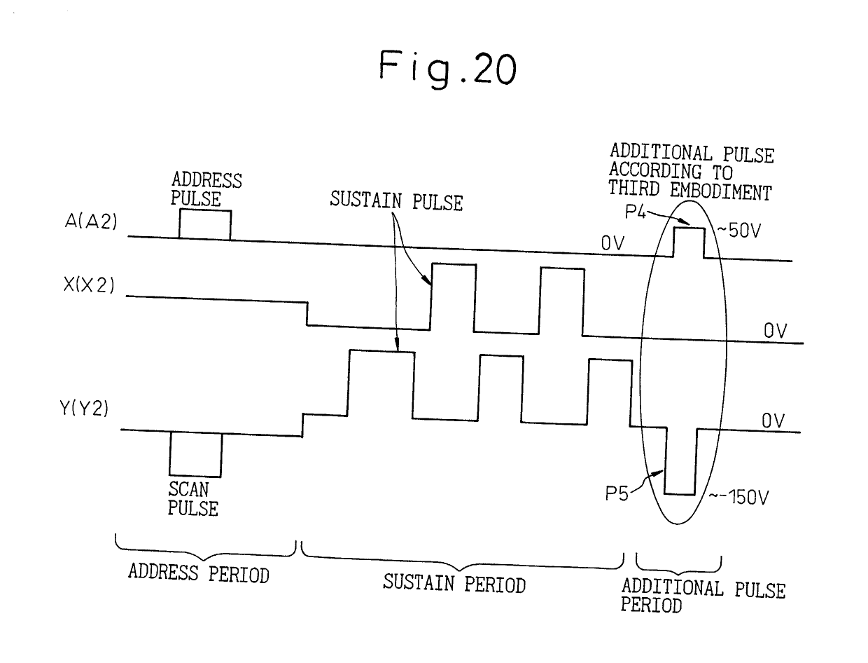

FIG. 20 is a diagram showing a driving waveform according to a third embodiment of a method of driving a PDP relating to the present invention.

As is apparent from a comparison between FIG. 20 and FIG. 16, according to the third embodiment, after a normal sustain period has been finished, a negative polarity pulse P5 that is equivalent to a voltage (for example, about −150 V) of a scan pulse is applied to the Y-electrode (Y2), and a positive polarity pulse P4 that is equivalent to a voltage (for example, about 50 V) of an address pulse is applied to the address electrode (A2). These additional pulses P4 and P5 are inserted after discharge by the positive polarity sustain pulse of the Y-electrode. Therefore, a discharge between the X-electrode and the Y-electrode and a discharge between the address electrode and the Y-electrode are carried out together. As a result, a large discharge (an auxiliary discharge) is generated, and this can remove the positive charge piled up at the address electrode side.

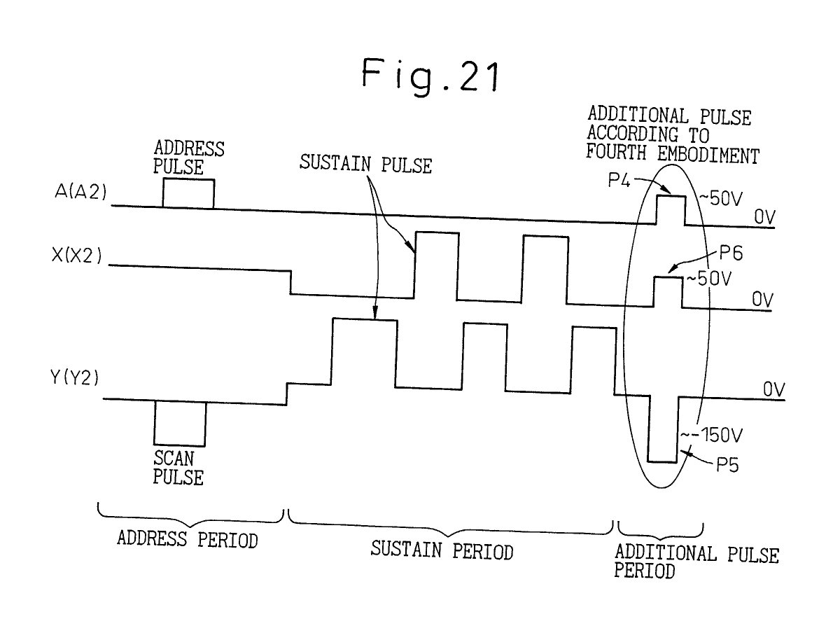

FIG. 21 is a diagram showing a driving waveform, according to a fourth embodiment, of a method of driving a PDP relating to the present invention.

As is apparent from a comparison between FIG. 21 and FIG. 20, according to the fourth embodiment, a positive polarity pulse P6 is also applied to the X-electrode (X2) during the additional pulse period after finishing the sustain period of the third embodiment. Based on this application, a larger discharge (an auxiliary discharge) is generated during the additional pulse period. This can more effectively remove the charge piled up at the address electrode side. The voltage of the additional pulse P6 to be applied to the X-electrode may be equivalent to that (for example, about 50 V) applied to the X-electrode during the address period, for example.

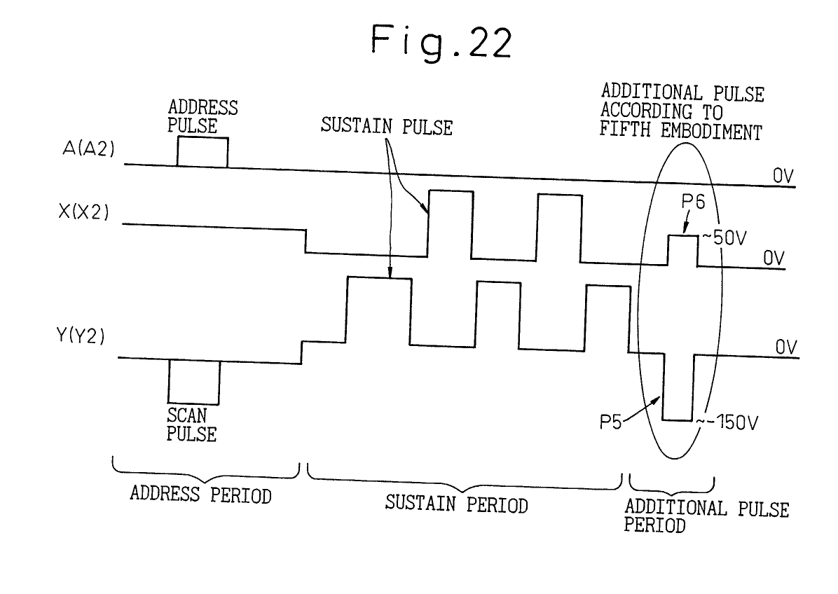

FIG. 22 is a diagram showing a driving waveform according to a fifth embodiment of a method of driving a PDP relating to the present invention.

According to the above-described third embodiment shown in FIG. 20 and fourth embodiment shown in FIG. 21, the additional pulse P4 is added to the address electrode (A2). Therefore, depending on the voltage between the address electrode (A2) and the Y-electrode (Y2), there is a case where a discharge is generated in all cells in which a lighting has been extinguished.

A discharge is generated securely in all the cells when the additional pulse P4 to be applied to the address electrode is set equivalent to that (for example, about 50V) of the address pulse during the address period and also when the additional pulse P5 to be applied to the Y-electrode (Y2) is set equivalent to that (for example, about −150 V) of the scan pulse. In other words, as the discharge is generated in all the cells even when the lighting on the screen is in the extinguished (a black display) state, the brightness of black increases, and this can lower the contrast.

Therefore, as shown in FIG. 22, according to the fifth embodiment, the additional pulse P4 is not applied to the address electrode (A2), and the additional pulses P6 and P5 are applied to the X-electrode (X2) and the Y-electrode (Y2) respectively so that an intensive discharge is carried out only between the X-electrode and the Y-electrode. According to the fifth embodiment, it is also possible to obtain the effect of preventing an abnormal discharge by removing the charge piled up at the address electrode side by the auxiliary discharge during the additional pulse period, although this effect is not as large as that obtained by the fourth embodiment.

The above-described driving method (additional pulses) of the third to fifth embodiments of the present invention may be implemented in all the sub-fields. However, this has a risk of lowering the contrast as described above. Therefore, it is also effective to implement the above driving method only once in one field.

While a description has been made of a case where the present invention is applied to mainly a PDP of the ALIS system (particularly the display of the odd lines), the application of the present invention is not limited to the PDP of the ALIS system. It is also possible to widely apply the present invention to a PDP in which a charge can easily move between adjacent cells (for example, between upper and lower adjacent cells) with short pitches of the cells in which a discharge is carried out.

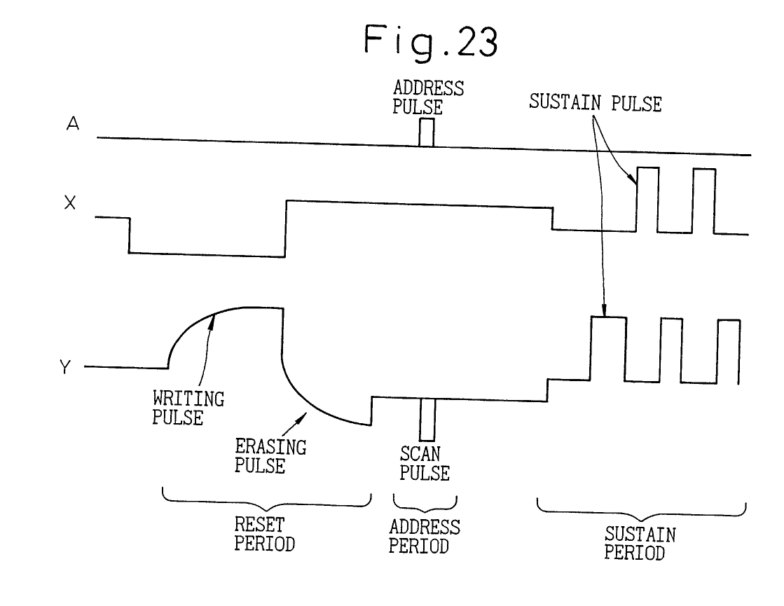

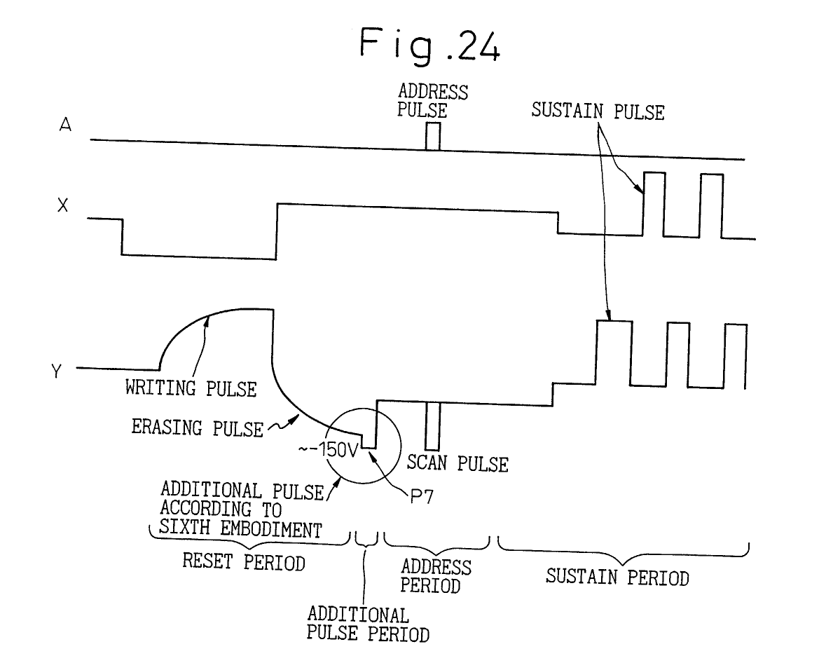

FIG. 23 is a diagram showing another example of a driving waveform according to a conventional method of driving a PDP. This shows a conventional example in comparison with an embodiment to be described later with reference to FIG. 24.

The conventional example shown in FIG. 23 is characterized in a reset pulse shape. According to this method, a pulse with a dull inclination is applied as a reset pulse, and a write discharge is carried out over all the cells. Thereafter, an erasing pulse with a dull inclination is similarly applied to erase the wall charge. This method is characterized in that, as the inclination of the pulse is dull, the discharge intensity is very small and the light emission volume is also small. Therefore, even when a reset (write/erase) discharge is executed in all sub-fields in the whole cells, a dark contrast is not lowered because of slight brightness. As a result, it is possible to obtain a stable operation and high display quality. Details of this driving technique are disclosed in, for example, Japanese Patent Application Laid-open Publication No. Hei 10-170825.

According to this method, however, a scale of discharging becomes small as the inclination of the erasing waveform is dull. Therefore, this has a problem in that the erasing of the wall charge becomes insufficient over the whole range of cells. In other words, even when wall charges on the phosphors above the X-electrodes (X), the Y-electrodes (Y) and the address electrodes (A) can be erased sufficiently, wall charges adhered to the phosphors on the side surfaces of the partitions (barriers) cannot be erased sufficiently. As a result, there has been a problem that a discharge is started based on only the erasing pulse without an application of the address pulse during the address period.

FIG. 24 is a diagram showing a driving waveform according to a sixth embodiment of a method of driving a PDP relating to the present invention.

As shown in FIG. 24, according to the sixth embodiment, an additional pulse P7 of a voltage equivalent to that (for example, about −150 V) of the scan pulse is applied for a short period of a few microseconds at the end of the erasing pulse. Based on this application, a discharge of a relatively large scale is generated to neutralize the wall charge, thereby avoiding an erroneous address.

More specifically, it has been confirmed that it is effective to set a voltage change of about 5 to 10 V to the additional pulse P7 that is steeply applied at the end of the erasing pulse, and to set the application time of this additional pulse P7 to about 1 to 5 μm, for example.

The application conditions of the additional pulse P7 to be applied at the end of the erasing pulse are different depending on the structure of the cells, and the voltage application during the address period and the sustain period. Therefore, the application conditions can be changed depending on the cases.

As explained above, according to the sixth embodiment, based on a secure reset operation (erase discharge), it is possible to prevent an occurrence of an erroneous address like the starting of a discharge by only the erasing pulse without the application of the address pulse during the address period.

As described above in detail, according to the present invention, it is possible to prevent an abnormal discharge by avoiding a distorted accumulation of charges on the display panel of the PDP. Further, according to the present invention, it is possible to prevent an occurrence of an erroneous address by only the erasing pulse without the application of the address pulse during the address period.

Many different embodiments of the present invention may be constructed without departing from the spirit and scope of the present invention, and it should be understood that the present invention is not limited to the specific embodiments described in this specification, except as defined in the appended claims.

What is claimed is:

1. A method of driving a plasma display panel having a plurality of first electrodes, a plurality of second electrodes adjacently disposed alternately, and a plurality of third electrodes formed to cross said first and second electrodes, comprising the steps of:
carrying out an address discharge between said second electrodes and said third electrodes;
carrying out an auxiliary discharge to decrease the volume of wall charges, accumulated on a display cell in which a sustain discharge is not intended, to a level which cannot generate a sustain discharge; and
carrying out a sustain discharge by alternately applying sustain pulses to said first and second electrodes.

2. The method of driving the plasma display panel as claimed in claim 1, further comprising the steps of:
generating a discharge in a selective cell by applying a voltage pulse, with the third electrode side set to have a first polarity and the second electrode side set to have a second polarity;
carrying out an address discharge to form wall charges of a first polarity on at least said second electrodes, with the first electrode side set to have a first polarity with respect to said second electrodes, and also to form wall charges of a second polarity on the first electrode side; and
applying a voltage pulse to said first or third electrodes or to both electrodes so as to set the third electrode side to have a first polarity and to set the first electrode side to have a second polarity, thereby to generate a discharge in a discharge cell that starts the discharge without an application to this cell a voltage pulse that brings about an address discharge in said third electrodes.

3. The method of driving the plasma display panel as claimed in claim 1, wherein a voltage to be applied to said third electrodes when carrying out the auxiliary discharge is equivalent to a voltage of an address pulse for carrying out an address discharge.

4. The method of driving the plasma display panel as claimed in claim 1, wherein a voltage to be applied to said second electrodes when carrying out the auxiliary discharge is a voltage which decreases a potential difference between the voltage applied to said second electrodes and a voltage of an additional pulse to be applied to said first electrodes.

5. The method of driving the plasma display panel as claimed in claim 4, wherein the voltage to be applied to said second electrodes when carrying out the auxiliary discharge is equivalent to a voltage of a non-selective electrode of said second electrodes during an address period.

6. The method of driving the plasma display panel as claimed in claim 1, wherein said first electrodes and said second electrodes are disposed in parallel alternately, and said third electrodes are orthogonal with said first and second electrodes.

7. A method of driving a plasma display panel having a plurality of first electrodes, a plurality of second electrodes adjacently disposed alternately, and a plurality of third electrodes formed to cross said first and second electrodes, comprising the steps of:
carrying out an address discharge between said second electrodes and said third electrodes;
carrying out a sustain discharge by alternately applying sustain pulses to said first and second electrodes; and
carrying out an auxiliary discharge of a scale larger than the scale of the sustain discharge carried out immediately before.

8. The method of driving the plasma display panel as claimed in claim 7, further comprising the steps of:
generating a discharge in a selective cell by applying a voltage pulse, with the third electrodes side set to have a first polarity and the second electrodes side set to have a second polarity;
forming wall charges of a first polarity on at least said second electrodes, with the first electrodes side set to have a first polarity with respect to said second electrodes, and also forming wall charges of a second polarity on the first electrodes side; and
applying a voltage pulse to said third or second electrodes or to both electrodes so as to set the third electrodes side to have a first polarity and to set the second electrodes side to have a second polarity.

9. The method of driving the plasma display panel as claimed in claim 7, wherein a voltage to be applied to said third electrodes when carrying out the auxiliary discharge is equivalent to a voltage of a voltage pulse to be applied to said third electrodes in order to execute an address discharge during an address period.

10. The method of driving the plasma display panel as claimed in claim 7, wherein a voltage to be applied to said third electrodes when carrying out the auxiliary discharge has a polarity opposite to the polarity of the potentials of said second and third electrodes during a sustain discharge period.

11. The method of driving the plasma display panel as claimed in claim 7, wherein a voltage to be applied to said second electrodes when carrying out the auxiliary discharge is equivalent to a voltage selectively applied to said second electrodes at the time of carrying out an address discharge.

12. The method of driving the plasma display panel as claimed in claim 7, wherein a voltage to be applied to said first electrodes when carrying out the auxiliary discharge is a voltage having a polarity opposite to the polarity of said second electrodes.

13. The method of driving the plasma display panel as claimed in claim 12, wherein the voltage to be applied to said first electrodes when carrying out the auxiliary discharge is equivalent to a voltage to be applied to said first electrodes at the time of carrying out an address discharge.

14. The method of driving the plasma display panel as claimed in claim 7, wherein the auxiliary discharge is carried out once in a plurality of sub-fields.

15. The method of driving the plasma display panel as claimed in claim 14, wherein the auxiliary discharge is carried out once in one frame or in one field.

16. The method of driving the plasma display panel as claimed in claim 7, wherein said first electrodes and said second electrodes are disposed in parallel alternately, and said third electrodes are orthogonal with said first and second electrodes.

17. A method of driving a plasma display panel having a plurality of first electrodes, a plurality of second electrodes adjacently disposed alternately, and a plurality of third electrodes formed to cross said first and second electrodes, for applying at a reset timing an erasing pulse having a dull inclination with respect to said second electrodes to which a scan pulse is applied, comprising the step of:
steeply changing a pulse voltage until when the pulse voltage becomes equivalent to a voltage of the scan pulse, at an end stage of the erasing pulse.

18. The method of driving the plasma display panel as claimed in claim 17, wherein said first electrodes and said second electrodes are disposed in parallel alternately, and said third electrodes are orthogonal with said first and second electrodes.

19. A plasma display panel comprising:
a plurality of first electrodes;
a plurality of second electrodes adjacently disposed alternately with said first electrodes;
a plurality of third electrodes formed to cross said first and second electrodes; and
a control circuit for having an address discharge carried out during said second electrodes and the third electrodes, wherein said control circuit has a sustain discharge carried out to decrease the volume of wall charges, accumulated on a display cell in which a sustain discharge is not intended, to a level which cannot generate a sustain discharge.

20. The plasma display panel as claimed in claim 19, wherein said first electrodes and said second electrodes are disposed in parallel alternately, and said third electrodes are orthogonal with said first and second electrodes.

21. A plasma display panel comprising:
a plurality of first electrodes;
a plurality of second electrodes adjacently disposed alternately with said first electrodes;
a plurality of third electrodes formed to cross said first and second electrodes; and
a control circuit for having an address discharge carried out during said second electrodes and said third electrodes, wherein said control circuit has an auxiliary discharge carried out in a scale larger than the scale of a sustain discharge carried out immediately before.

22. The plasma display panel as claimed in claim 21, wherein said first electrodes and said second electrodes are disposed in parallel alternately, and said third electrodes are orthogonal with said first and second electrodes.

23. A method of driving a plasma display panel having a plurality of first electrodes, a plurality of second electrodes adjacently disposed alternately, and a plurality of third electrodes formed to cross said first and second electrodes, comprising the steps of:
carrying out an address discharge between said second electrodes and said third electrodes; and
carrying out a sustain discharge by alternately applying sustain pulses to said first and second electrodes, wherein an auxiliary discharge is carried out between said first electrodes and said third electrodes, during the address discharge and the sustain discharge.
